(19) United States
(12) Patent Application Publication
(10) Pub. No.: US 2002/0079994 A1
(43) Pub. Date: Jun. 27, 2002

(54) Relay

(76) Inventors: Leopold Mader, Moedling (AT); Rudolf Mikl, Arbesthal (AT)

Correspondence Address: Tyco Technology Resources, Suite 450, 4550 New Linden Hill Road, Wilmington, DE, 19808, US

(21) Appl. No.: 09/862,003

(22) Filed: May 22, 2001

(30) Foreign Application Priority Data
Jun. 2, 2000 (DE) 100 27 361.0

(51) Int. Cl. H01H 67/02

(52) U.S. Cl. 335/129

(57) ABSTRACT

For the purpose of testing a relay, a safety relay comprises a key (12) arranged in a housing cover and which acts upon a lever (38) pivotally mounted on the inside of the housing. Due to the pivoting of the lever a movable switching contact carrier of the relay is moved. To avoid excessive deviation of the switching contact carrier through excessive lever force and therefore a possible plastic deformation of the contact carrier springs, the force which is possibly applied to the switching contact carrier is restricted by a U-shaped spring (40) held by the lever (38). A pressure leg (48) is biased by a latching lug (52a, 52b) supported by a peg formed as one piece with the lever (38). Consequently the switching contact carrier is moved via the spring with only a predetermined maximum force, so that a deformation of the springs supporting the contact pieces is avoided and the contact pieces maintain the required specified contact distance.

### BACKGROUND OF THE INVENTION

The invention relates to a relay comprising at least one contact set and a manual operation device for moving the switching contact(s) via a lever acting upon a switching contact carrier.

### DESCRIPTION OF THE PRIOR ART

Relays come in multiple embodiments and serve multiple purposes. The present invention describes an example of a safety relay, which for testing purposes can be manually operated. A relay typically comprises one or several make contacts and one or several break contacts which, during current flow of the relay reel, close by joining together the contact pieces previously separated by a predetermined distance, or open by moving apart the previously contacting contact pieces. To test such a safety relay, a housing cover comprises a key, the activation of which causes a lever located inside the housing to pivot and to act upon the armature and/or a switching contact carrier (comb) to carry out the above-mentioned switching process.

Safety relays of this type require a contact distance of 0.5 mm to be permanently maintained. If the comb functioning as a switching contact carrier is moved by the manual operation device, thereby causing the two contact pieces to be bonded together, and thus impeding the attempted movement of the switching contact carrier due to the bonding of the contact pieces, the person monitoring the relay may increase the force applied to the lever acting upon the switching contact carrier in an attempt to loosen the bonding between one or several coupled switching contacts and break contacts. Since, as a result of a constantly progressing miniaturisation trend, components of this type of relay are becoming increasingly delicate which can result in a bending of the switch (make) spring carrying the switching contact and/or the break (rest) spring carrying the break contact. When the bonding is loosened and the switching contact carrier resumes its starting position, the above-mentioned stipulated contact distance is possibly no longer ensured, since one or several springs may have been bent.

### SUMMARY OF THE INVENTION

It is an aim of the invention to provide a relay of the above art, whereby a change in the predetermined contact distance, caused by a manual operation of the relay, can be reliably avoided. This aim is achieved in a relay by providing a spring, which is arranged between the lever and the switching contact carrier and which restricts the force applied to the switching contact carrier by the lever.

The term “lever” refers to a lever which is pivotally arranged in a relay housing, but it can also describe a slider, which acts upon the switching contact carrier. According to the invention, the purpose of the spring is to restrict the force applied to the switching contact carrier during testing of the safety relay. The mechanism involving the spring is thus designed in such a way that, even under a maximum stroke movement of the lever, the spring is still not completely compressed. This measure ensures that in each case the force applied to the switching contact carrier is restricted to a maximum value. This maximum force is then calculated by correspondingly dimensioning the structural components involved in the movement of the switching contact carrier in such a way that, under this force, the springs, and in particular the break contact springs, are not bent to the extent that plastic deformation occurs, resulting in a change in the contact distance.

A particular embodiment provides that the lever, at a distance from its pivot axis, comprises a pressure absorber and, at one of the spring's legs, supports an approximately U-shaped spring pointing in the pivot direction. The other leg of the U-shaped spring is then positioned—preferably with its free end—at a short distance facing the armature of the relay or a part of the switching contact carrier mechanically connected to it. When the lever is pivoted, the spring engages the armature or the switching contact carrier (comb), shifting the latter, so that the contact pieces of the make contact close and the contact pieces of the break contact(s) open.

In an embodiment the spring is biased. Due to the biasing of the spring, the force with which the switching contact carrier is to be moved can be pre-adjusted. It is conceived that the leg of the U-shaped spring supported by the lever is penetrated by a peg which projects from the lever and which also penetrates the other leg of the spring, holding it in a biased position via latching lugs. The lever and the spring are assembled together prior to being mounted in the relay. This results in a simple component, which is economical to manufacture and easy to assemble and which ensures in a simple manner that the springs supporting the contact pieces do not change their break position during the testing of the relay.

### BRIEF DESCRIPTION OF THE DRAWINGS

FIGS. 1a and 1b both illustrate an exploded view of an embodiment of a relay according to the invention, whereby FIG. 1b shows a relay carrier with the components of the relay itself including the manual operation device and FIG. 1a shows a housing cover with an integrally injected key.

FIG. 2 illustrates part of a relay carrier, in which a lever of a manual operation device and a U-shaped spring which is to be positioned on the lever are arranged, whereby the latter two parts are represented separately and, like the part of the relay carrier, in a perspective view;

FIG. 3 illustrates a perspective view of the assembled parts shown in FIG. 2;

FIG. 4 illustrates a side view of the lever with a biased U-shaped spring of the manual operation device supported by the lever; and

FIG. 5 illustrates the arrangement according to FIG. 4 with a non-biased spring.

### DETAILED DESCRIPTION OF THE PREFERRED EMBODIMENT

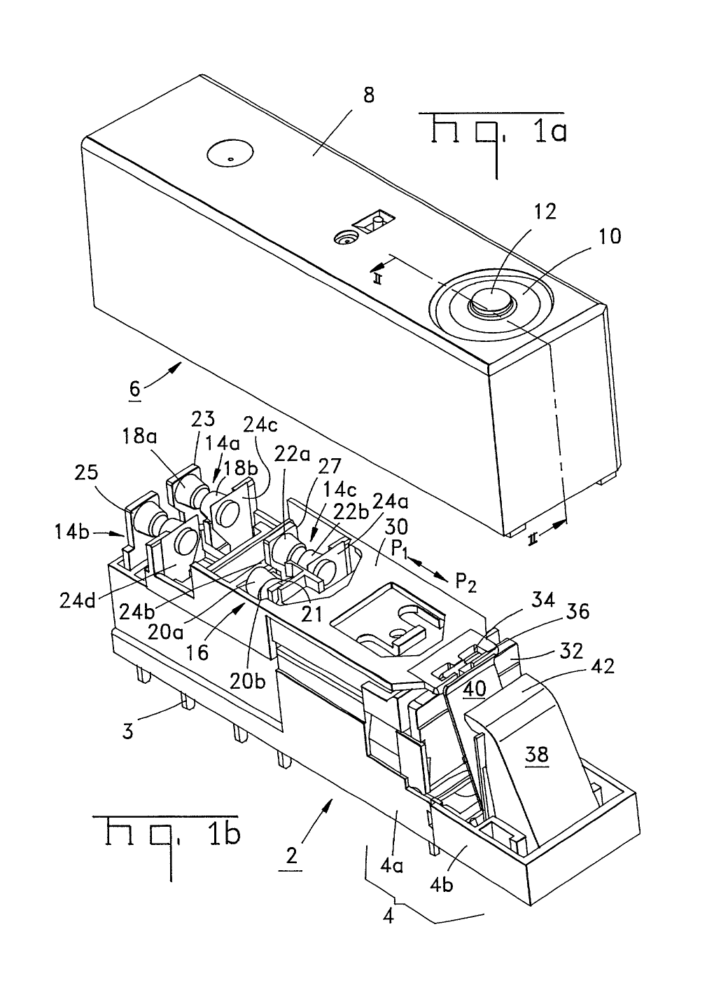

According to FIG. 1b, connection pins 3 project from the covered bottom part of a relay carrier 4 consisting of two parts 4a, 4b of a relay 2. The connecting pins are positioned to be soldered to a switching board (not shown). The relay housing cover 6, represented in FIG. 1a as lifted off the actual relay, is sealed by the relay carrier 4, resulting in an overall water-proof arrangement.

The housing cover 6 of the relay is a small box-shaped part with an open bottom (not shown), four side walls and a top cover 8, in which a key 12 is arranged via a key carrier 10. The key carrier 10 and the key 12 are manufactured as one piece with the housing cover 6 through injection moulding of transparent polycarbonate or other similar material having the characteristics required.

Referring to FIG. 1b four contact sets are shown. In this embodiment three make contacts 14a, 14b and 14c and one break contact 16 are shown. In the resting position shown in FIG. 1b of the relay 2, the individual contact pieces 18a and 18b of the make contact 14a exhibit a stipulated contact distance of 0.5 mm. The same applies to the contact pieces of both further make contacts 14b and 14c, as for instance the contact pieces 22a and 22b of the make contact 14c. The contact pieces 20a and 20b of the break contact 16 are in contact with one another. The contact piece 20b is supported by a break spring 21, and the contact piece 20a of the break contact 16 is supported by a switch (make) spring 24b. A switch spring 24a supports the contact piece 22b of the make contact 14c. A break spring 27 supports the contact piece 22a of the make contact 14c. A switch spring 24c supports the contact piece 18b of the make contact 14a, the break contact piece 18a of which is supported by a break spring 23. The make contact 14b comprises a switch spring 24d and a break spring 25.

During current flow, the comb 30 of the relay moves in the direction of arrow P1, whereby the switch springs 24a, 24b, 24e and 24d are also moved in the direction of arrow P1 with the contact pieces they support, so that the break contact 16 opens and the make contacts 14a, 14b, 14c close. Without current flow the comb 30 moves back in the direction of arrow P2 together with the parts it supports.

The above process can also be activated manually, e.g. for testing purposes, in which case the key 12 represented in FIG. 1a is pushed. The interior of the key 12 acts upon a pressure absorbing surface 42 of a lever 38, which is pivotally mounted in the relay carrier part 4b. A lever 38 is coupled to a spring 40. The free, slightly bent end of the spring 40, when in a resting position, is spaced a minor distance from an armature 32 of the relay as well as to a projection 36 of the comb 30. When the key 12 is activated, the lever 38 and with it the spring 40 are moved in the direction of the armature 32 and the comb 30, so that the free end of the spring 40 presses against the armature 32. The free end of the armature engages in a recess 34 of the projection 36 and moves the comb 30, so that the above-described switching process takes place.

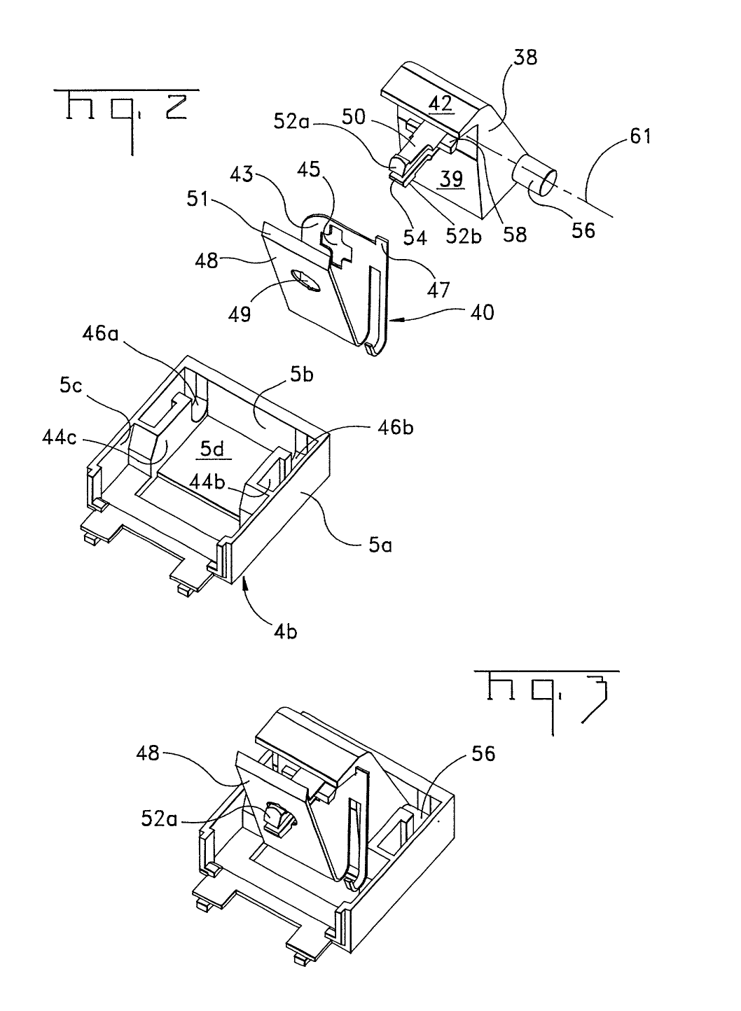

FIG. 2 represents a perspective, exploded view of the part 4b of the relay carrier shown at the bottom right of FIG. 1b, the lever 38 and the spring 40.

The part 4b of the relay carrier comprises on an approximately square bottom 5d three attached side walls 5a, 5b and 5c, whereby to the inside of each of the side walls 5a and 5c, a bearing wall 44b or 44a is joined, which in the region close to the side wall 5b form a drag bearing recess 46b or 46a.

The drag bearing recesses 46b and 46a serve to receive stub axles 56, which define a pivot axis 61 at the bottom part of the lever 38 (one stub axle is hidden in FIG. 2).

Beneath the pressure absorbing surface 42, a peg 50 projects from the front side 39 of the lever 38 and is divided by a slit 54 in two halves, each one of which comprises an outward pointing latching lug 52a or 52b. In the assembled version of the arrangement shown in FIG. 2, the peg 50 penetrates a through opening 45 in a leg of the U-shaped spring 40 functioning as a supporting leg 43, as well as a through opening 49 in the other leg of the U-shaped spring 40 functioning as a pressure leg 48.

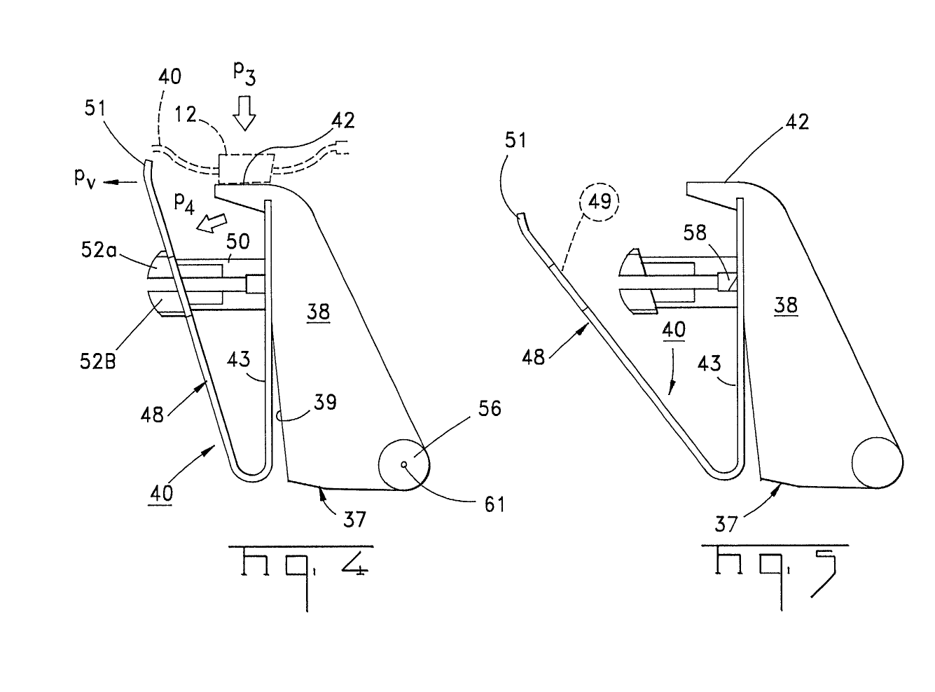

As can be seen in FIG. 5, the spring 40 is initially positioned on the peg with the support leg 43 and fixed with a wedge 58. Then the pressure leg 48 is pressed, so that both latching lugs 52a and 52b are pressed together when penetrating the through opening 49 and then spring back to their starting position, so that the situation according to FIG. 4 is reached. The pressure leg 48 of the spring 40 is thus biased.

The outer end of the pressure leg 48 forms a pressure pad 51, which is positioned opposite the armature 32 (FIG. 1b) at a set distance.

When according to FIG. 4, a force is applied via the key 12 in the direction of the arrow P3 on the pressure absorbing surface 42 of the lever 38, the lever 38 is pivoted around its pivot axis 61 in the direction of the arrow P4. The pressure pad 51 of the pressure leg 48 then presses against the armature 32 in the direction of the arrow PV with a force corresponding to the bias of the spring.

Since the stroke of the key 12 is restricted, in that its bottom side 37 hits the bottom 5d of the relay carrier part 4b, the spring 40 is never deformed to the extent that, for instance, its pressure leg 48 hits the region of the pressure absorbing surface 42 of the lever 38. In each case the maximum force applied via the pressure leg 48 and the pressure pad 51 to the armature 32 and therefore to the switching contact carrier (comb) 30, is restricted to a maximum value. Damage to the switching contacts due to excessive force action on the switching contact carrier 30 is avoided.

The spring 40 is secured to the lever 38 in the manner shown in FIG. 2, whereby the non-circular through openings 43 and 49 and the corresponding design of the peg 50 in conjunction with a stop lug 47 of the spring 40 ensure that both parts are firmly held together. The structure represented in FIG. 3 is attached and sealed to the other part 4a of the relay carrier 4 in accordance with FIG. 1b. Once the assembly is complete, the housing cover 6 is placed and sealed, so that the entire component is sealed.

I/We claim:

1. A relay comprising:
at least one contact set;
a manual operation device for moving at least one switching contact via a lever acting upon a switching contact carrier;
a spring is positioned between the lever and the switching contact carrier, the spring restricts the force applied to the switching contact carrier via the lever.

2. The relay recited in claim 1 wherein the lever is pivotally mounted in a relay housing around a pivot axis, the relay housing having a pressure absorber at a distance to the pivot axis, and supporting an approximately U-shaped spring pointing in the pivot direction at a first of its legs.

3. The relay recited in claim 2 wherein a second leg of the U-shaped spring forms at its free end a pressure pad, which is positioned opposite an armature of the relay at a minor distance.

4. The relay recited in claim 1 wherein the spring is biased.

5. The relay recited in claim 2 wherein the first leg of the spring supported by the lever is penetrated by a peg projecting from the lever, which also penetrates the second leg of the spring and holds the latter via latching lugs in a biased position.
